(19) United States
(12) Patent Application Publication
(10) Pub. No.: US 2018/0361619 A1
(43) Pub. Date: Dec. 20, 2018

(54) Clay Body Moisture Control and Drying Apparatus

(71) Applicant: Guangzhen Zhou, San Jose, CA (US)

(72) Inventor: Guangzhen Zhou, San Jose, CA (US)

(21) Appl. No.: 15/625,412

(22) Filed: Jun. 16, 2017

(51) Int. Cl. B28B 11/24; F26B 3/04; F26B 9/00; F26B 21/00; F26B 21/10; F26B 23/04; F26B 25/10

(52) U.S. Cl. CPC B28B 11/243; F26B 3/04; F26B 9/003; F26B 21/001; F26B 2210/02; F26B 23/04; F26B 25/10; B28B 11/247; F26B 21/10

(57) ABSTRACT

A moisture control and drying apparatus includes a heating chamber having a bottom wall and a continuous upstanding side wall that together define an interior area. A heating assembly situated in the interior area of the heating chamber is configured to emit heat when actuated. A support platform is coupled to a peripheral upper edge of the heating chamber that blocks access to the interior area of the heating chamber, the support platform defining a water collection channel about an outer edge thereof. A transparent evaporation cover includes a closed top cap and a continuous side wall extending downwardly therefrom that has a lower edge removably nested in the water collection channel of the support platform and defines an open bottom. The support platform defines apertures so that heated air in the heating chamber is in fluid communication with the interior space defined by the evaporation cover.

### BACKGROUND OF THE INVENTION

This invention relates generally to drying equipment in the field of ceramics and, more particularly, to a moisture control and drying apparatus having a damp box to hold a clay object and a heating assembly configured to dry the clay object more slowly and consistently so as to prevent cracking due to uneven drying.

Custom clay objects often require extensive processing, including a drying process, even though they may need to be completed in a short period of time. Heating and drying a wet clay object too quickly or unevenly immediately following its completion, however, is likely to result in cracking and degradation of quality. The moisture in the clay object sinks downward while water evaporates upwardly—a reality that results in the upper and outer parts of the clay object cracking.

Various equipment is used in the ceramic industry for drying clay. However, the unevenness and quickness of the traditional clay drying equipment often results in cracking of the clay object. In some instances, the existing equipment actually speeds up the drying technique and results in unsightly or weak products.

Therefore, it would be desirable to have a moisture control and drying apparatus for drying a clay object, such an ornamental porcelain piece, in a steady, slow, and distributed manner that minimizes cracks and other undesirable effects of fast and inconsistent drying techniques. Further, it would be desirable to have a moisture control and drying apparatus that collects condensed water that evaporates from a drying clay object.

### SUMMARY OF THE INVENTION

A moisture control and drying apparatus for processing a clay object according to the present invention includes a heating chamber having a bottom wall and a continuous side wall extending upwardly from the bottom wall that together define an interior area, the side wall having a peripheral upper edge thereof defining an open upper end. A heating assembly is situated in the interior area of the heating chamber that is configured to emit heat when actuated. A support platform is coupled to the peripheral upper edge of the heating chamber that is configured to block access to the interior area of the heating chamber, the support platform defining a water collection channel about an outer edge thereof.

A transparent evaporation cover includes a closed top cap and a continuous side wall extending downwardly from the closed top cap and has a lower edge removably nested in the water collection channel of the support platform and defines an open bottom. The support platform defines a plurality of apertures so that the heated air in the interior area of the heating chamber is in fluid communication with the interior space defined by the evaporation cover.

Therefore, a general object of this invention is to provide moisture control and drying apparatus for drying a clay object, such an ornamental porcelain piece, in a steady, uniform, and distributed manner that minimizes cracks and other undesirable effects of fast and inconsistent drying techniques.

Another object of this invention is to provide a moisture control and drying apparatus, as aforesaid, having a heating chamber that heats ambient air therein and having a support platform configured to support the clay object while regulating an amount and speed with which the heated air is utilized to dry the clay object.

Still another object of this invention is to provide a moisture control and drying apparatus, as aforesaid, that seals moisture in a dry box environment so that it evaporates and condenses, the condensed moisture being directed to a water collection channel and then to a water collection reservoir.

Yet another object of this invention is to provide a moisture control and drying apparatus, as aforesaid, in which an evaporation cover that encloses the clay object is constructed of a transparent material so that the drying process may be viewed.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a moisture control and drying apparatus according to a preferred embodiment of the present invention;

FIG. 2 is an exploded view of the moisture control and drying apparatus as in FIG. 1;

FIG. 3a is a side view of the moisture control and drying apparatus as in FIG. 1;

FIG. 3b is a sectional view taken along line 3b-3b of FIG. 3a;

FIG. 3c is an isolated view on an enlarged scale taken from FIG. 3b;

FIG. 3d is an isolated view on an enlarged scale taken from FIG. 3b.

### DESCRIPTION OF THE PREFERRED EMBODIMENT

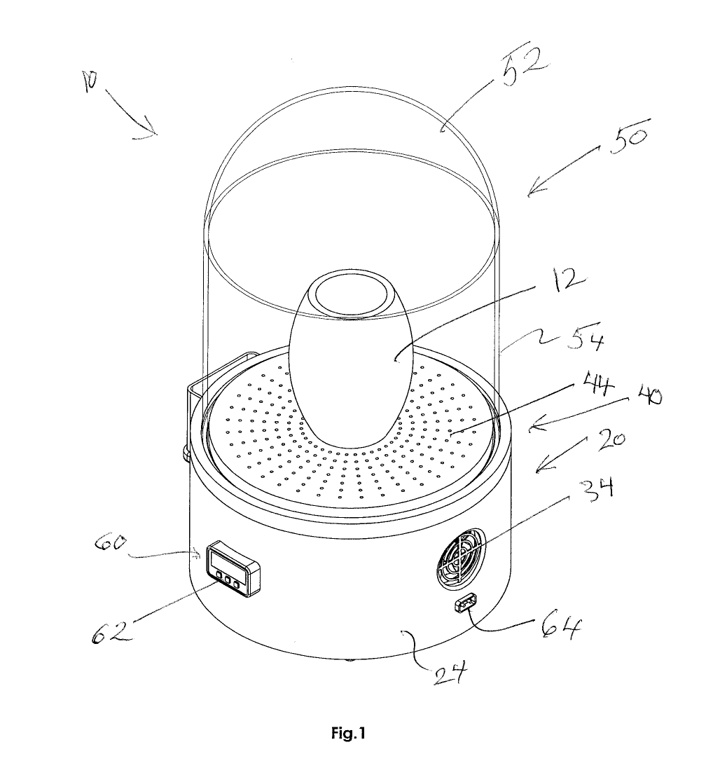

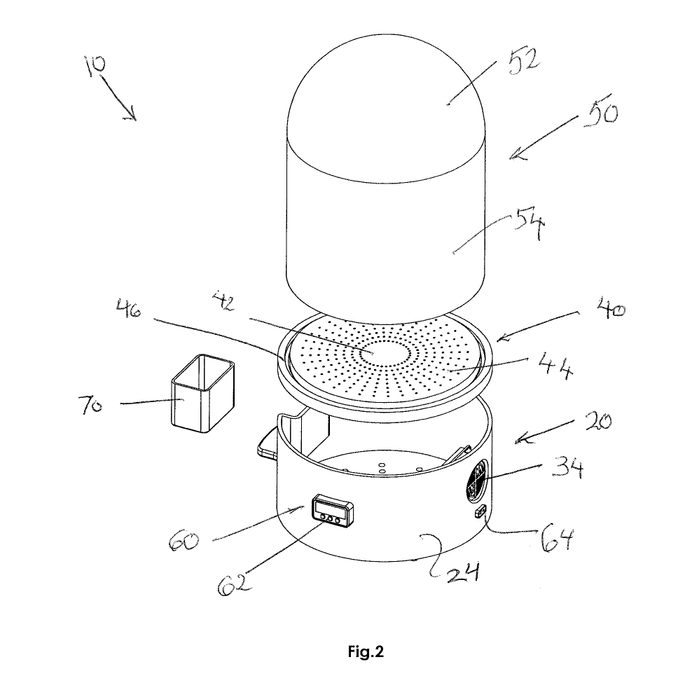

A moisture control and drying apparatus for processing a clay object will now be described with reference to FIGS. 1 to 3d of the accompanying drawings. The moisture control and drying apparatus 10 includes a heating chamber 20, a heating assembly 30 situated in the heating chamber 20, a support platform 40 coupled to an upper end of the heating chamber 20 that defines a plurality of apertures 44 and a water collection channel 46, and a transparent evaporation cover 50 having a lower edge nested in the water collection channel 46 and having a domed configuration for condensing collected evaporated moisture and directing it into the water collection channel 46.

The heating chamber 20 serves as the base of the apparatus 10. The heating chamber 20 may include a bottom wall 22 and a continuous side wall 24 extending upwardly from a peripheral edge of the bottom wall 22. Preferably, the bottom wall 22 and upstanding side wall 24 have a circular and cylindrical configuration although having a square, rectangular, or other geographic configuration would also work. The side wall 24 of the heating chamber 20 includes an upper edge defining an open upper end. Together, the bottom wall 22 and upstanding side wall 24 define a chamber having an open interior area for containing other components and heated ambient air as will be described more fully below. A plurality of “feet” 23 may be coupled to an exterior surface of the bottom wall 22 to enhance grip or traction on a surface such as a countertop or the like. In an embodiment, the bottom wall may include a plurality of vent holes that may be selectively opened during the drying process and closed when used as a damp box.

The heating assembly 30 is situated in the interior area of the heating chamber 20 and may be coupled to an interior surface of the side wall 24 thereof. More particularly, the heating assembly 30 may include an electronic heating element 32 that heats the surrounding ambient air within the interior area when actuated and energized with current. Further, the heating assembly 30 may include a fan 34 configured to push or circulate the heated ambient air when energized. Preferably, the heating element 32 and fan 34 are energized simultaneously to heat and circulate heated air although they may be programmed to operate in another manner as controlled by a control module 60 or circuitry as will be described later.

The support platform 40 has a generally planar configuration coupled to and extending between upper peripheral edges of the heating chamber 20. The shape configuration of the support platform 40 is substantially similar to that of the heating chamber 20. For instance, if the heating chamber 20 has a circular configuration, then the support platform 40 also has a circular configuration. The support platform 20 is coupled to the upper edge of the side wall 24 of the heating chamber 20 so as to be positioned intermediate the interior area of the heating chamber 20 and the interior space defined by the evaporation cover 50 as will be described below. As such, the support platform 40 blocks upper access into the interior area of the heating chamber 20. An outer or peripheral edge of the support platform 20 defines a water collection channel 46 configured to collect condensed moisture as will be described later.

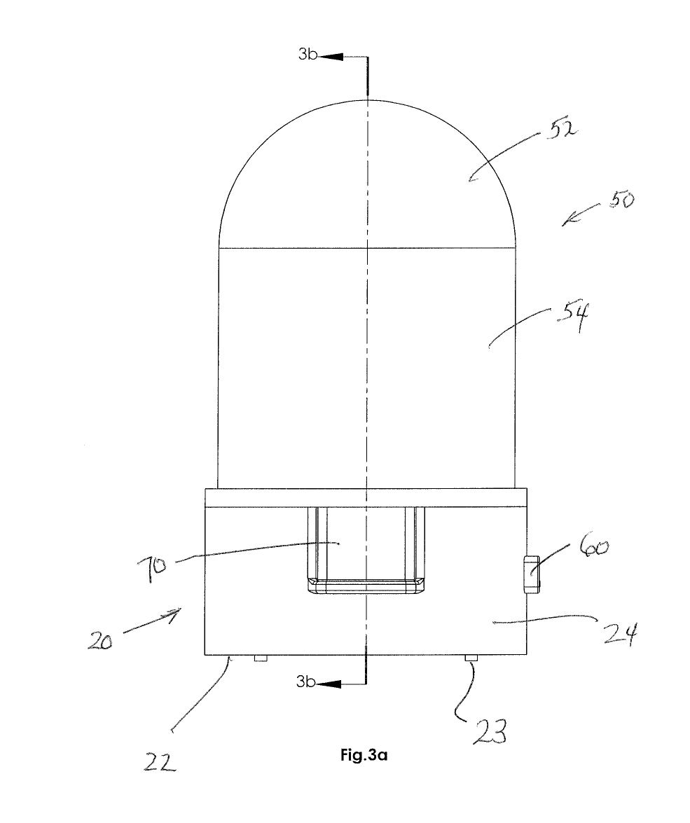

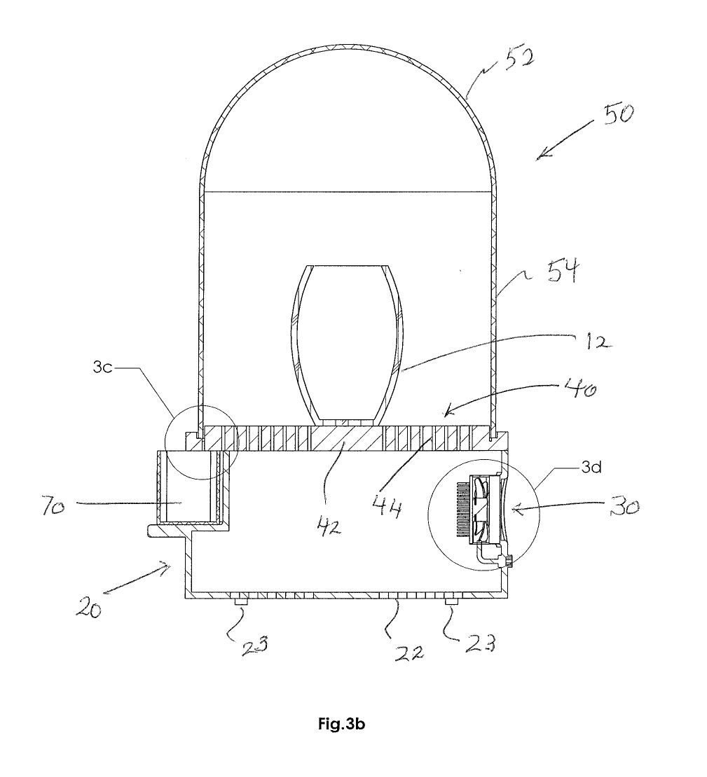

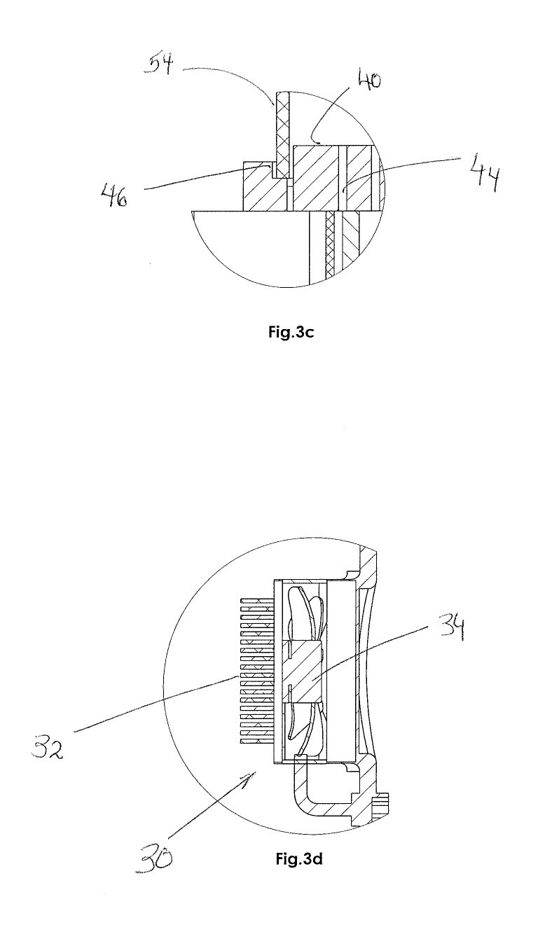

The support platform 40 includes a solid support portion 42 at a central point between opposed peripheral edges. The support portion 42 is particularly adapted to support a clay object thereon, such as a vase or other ornamental piece (FIG. 3b). Further, the support platform 40 defines a plurality of apertures 44 to facilitate fluid communication between the interior area of the heating chamber 20 and the interior space defined by the evaporation cover 50 as will be described below. The support platform 40 may be in the form of a grate having multiple openings. The plurality of apertures 44 are spaced apart from one another and may be arranged in a radial and concentric pattern. In use, the apertures 44 allow heated air to move from interior area of the heating chamber 20 to the interior space defined by the evaporation cover 50. The predetermined pattern of the apertures 44 causes a controlled amount of heated air to be pushed or circulated into the interior space of the evaporation cover so as to slow and control the rate at which the clay piece is dried.

The evaporation cover 50 includes a closed top cap 52 and a continuous side wall 54 extending downwardly from a lower edge of the top cap 52, the side wall 54 having a lower edge selectively nested in the water collection channel 46 (FIG. 3c). In an embodiment, the evaporation cover 50 may take the shape of a cylinder having a domed top although it is understood that the evaporation cover 50 may have a rectangular, square, truncated, or other configuration. Preferably, the evaporation cover 50 is constructed or a transparent material such as plastic or glass so that the process of drying a clay piece can be monitored visually. The interior surface of the side wall 54 of the evaporation cover 50 is a smooth surface so that water having condensed thereon may travel freely thereon until reaching the water collection channel 46 and, eventually, the water collection reservoir 70 discussed below.

A water collection reservoir 70 may be coupled to the side wall 24 of the heating chamber 20 (FIG. 3b). In an embodiment, the water collection reservoir 70 may be a bottle or similar container that defines an open top. The water collection reservoir 70 may be removably coupled to the heating chamber 20, such as by sliding into a recessed or inset compartment. In any case, the water collection reservoir 70 is selectively position to be in fluid communication with the water collection channel 46 of the support platform 40 so as to receive water collected by the water collection channel 46. When the water collection reservoir 70 is full, or on predetermined occasions, the water collection reservoir 70 may be removed, dumped, or otherwise replaced with an empty water collection reservoir 70. In use, as moisture from a drying clay object is condensed on the evaporation cover 50 and runs down into the water collection channel 46, the water is received into the water collection reservoir 70 and may be dumped as needed.

In another aspect, the moisture control and drying apparatus 10 may include a control module 60 (also referred to as an electronics box) in data or electric communication with the heating assembly 30. The control box 72 may include a processor, controller, or circuitry and may be programmed to operate the heating assembly 30. More particularly, the control module 60 may include an input controls 62 configured to energize the heating element 32 and fan 34 when appropriately operated by a use or as may be programmed. The input controls 62 may be buttons, a touch screen display, or the like. In addition, the control module 60 may be electrically connected to a power source such as a battery (not shown) or to a plug 64 (FIG. 1) configured to connect to an external source of current.

In use, the evaporation cover 50 may be removed so that a clay object 12 that is still wet from being formed may be inserted and positioned upon the support portion 42 of the support platform 40. Then, the evaporation cover 50 may be returned to enclose the clay object 12, i.e. the lower edge of the side wall 54 of the evaporation cover 50 is nested in the water collection channel 46 as described above. A user may then actuate the heating assembly 30 using the input controls 62 of the control module 60 to start or set the heating assembly heating ambient air. Upon operation of the fan 34, the heated air is circulated or pushed through respective apertures 44 into the interior space of the evaporation container so as to dry the clay object in a controlled and consistent manner. As the clay object is dried, moisture is evaporated and rises and impacts the interior surface of the evaporation cover 50. The moisture condenses as water droplets and runs down the surface by operation of gravity. The condensed water is collected first by the collection channel 46 and second is received into the water collection reservoir 70 as described above.

It is understood that while certain forms of this invention have been illustrated and described, it is not limited thereto except insofar as such limitations are included in the following claims and allowable functional equivalents thereof.

1. A moisture control and drying apparatus for processing a clay object, comprising:
a heating chamber having a bottom wall and a side wall extending upwardly from said bottom wall that together define an interior area, said side wall having a peripheral upper edge thereof defining an open upper end;
a heating assembly situated in said interior area of said heating chamber that is configured to emit heat when actuated;
a support platform coupled to said peripheral upper edge of said heating chamber that is configured to block access to said interior area of said heating chamber, said support platform defining a water collection channel about an outer edge thereof;
an evaporation cover having a closed top cap and a side wall extending downwardly from said closed top cap, said side wall having a lower edge selectively nested in said water collection channel of said support platform and defining an open bottom such that said side wall and said closed top cap define an open interior space in communication with said support platform.

2. The moisture control and drying apparatus as in claim 1, further comprising a water collection reservoir coupled to said side wall of said heating chamber and in communication with said water collection channel, whereby to collect water accumulated in said water collection channel.

3. The moisture control and drying apparatus as in claim 1, wherein said water collection reservoir is selectively removable from said heating chamber.

4. The moisture control and drying apparatus as in claim 1, wherein said heating assembly includes an electronic heating element that heats ambient air when energized.

5. The moisture control and drying apparatus as in claim 4, wherein said heating assembly includes a fan that circulates said heated air when energized.

6. The moisture control and drying apparatus as in claim 1, wherein said support platform defines a plurality of apertures so that said heated air in said interior area of said heating chamber is in fluid communication with said interior space defined by said evaporation cover.

7. The moisture control and drying apparatus as in claim 6, wherein:
said support platform includes a solid support portion for supporting the clay object within said interior space of said evaporation cover;
said plurality of plurality of apertures are spaced apart in a concentric arrangement that extends radially away from said solid support portion such that said heated area is communicated in a predetermined distribution pattern.

8. The moisture control and drying apparatus as in claim 1, wherein:
said side wall of said heating chamber is a continuous side wall such that said heating chamber has a cylindrical configuration;
said side wall of said evaporation cover is a continuous side wall such said evaporation cover has a cylindrical configuration.

9. The moisture control and drying apparatus as in claim 1, further comprising a control module in data communication with said heating assembly, said control module having input controls configured to energize said heating assembly when operated by a user.

10. The moisture control and drying apparatus as in claim 1, wherein said evaporation cover is constructed of a transparent material and having a smooth interior surface on which evaporated moisture is able to pass across freely.

11. The moisture control and drying apparatus as in claim 1, wherein said evaporation cover and said heating chamber together define a damp box that is sealed to prevent loss of moisture within said interior area and said interior space, respectively.

12. The moisture control and drying apparatus as in claim 11, wherein said closed top cap and said side wall of said evaporation cover together define a dome configured to collect evaporated moisture that directs said collected evaporated moisture to said water collection channel when said collected evaporate moisture condenses.

13. A moisture control and drying apparatus for processing a clay object, comprising:
a heating chamber having a bottom wall and a continuous side wall extending upwardly from said bottom wall that together define an interior area, said side wall having a peripheral upper edge thereof defining an open upper end;
a heating assembly situated in said interior area of said heating chamber that is configured to emit heat when actuated;
a support platform coupled to said peripheral upper edge of said heating chamber that is configured to block access to said interior area of said heating chamber, said support platform defining a water collection channel about an outer edge thereof; and
an evaporation cover constructed of a transparent material and having a closed top cap and a continuous side wall extending downwardly from said closed top cap, said side wall having a lower edge removably nested in said water collection channel of said support platform and defining an open bottom such that said side wall and said closed top cap define an open interior space in communication with said support platform;
wherein said support platform defines a plurality of apertures so that said heated air in said interior area of said heating chamber is in fluid communication with said interior space defined by said evaporation cover.

14. The moisture control and drying apparatus as in claim 13, further comprising a water collection reservoir releasably coupled to said side wall of said heating chamber and in communication with said water collection channel, whereby to collect water accumulated in said water collection channel.

15. The moisture control and drying apparatus as in claim 13, wherein said heating assembly includes an electronic heating element that heats ambient air when energized.

16. The moisture control and drying apparatus as in claim 15, wherein said heating assembly includes a fan that circulates said heated air when energized.

17. The moisture control and drying apparatus as in claim 13, wherein:
said support platform includes a solid support portion for supporting the clay object within said interior space of said evaporation cover;
said plurality of plurality of apertures are spaced apart in a concentric arrangement that extends radially away from said solid support portion such that said heated area is communicated in a predetermined distribution pattern.

18. The moisture control and drying apparatus as in claim 13, further comprising a control module in data communication with said heating assembly, said control module having input controls configured to energize said heating assembly when actuated by a user.

19. The moisture control and drying apparatus as in claim 13, wherein said evaporation cover includes a smooth interior surface on which evaporated moisture condenses and passes downwardly by force of gravity.

20. The moisture control and drying apparatus as in claim 13, wherein said evaporation cover and said heating chamber together define a damp box that is sealed to prevent loss of moisture within said interior area and said interior space, respectively.
